(19) United States
(12) Patent Application Publication
(10) Pub. No.: US 2014/0164608 A1
(43) Pub. Date: Jun. 12, 2014

(54) CONTENT TRANSMISSION SYSTEM

(71) Applicant: Electronics and Telecommunications Research Institute, Daejeon (KR)

(72) Inventors: Dong Myoung BAEK, Daejeon (KR); Ho Young SONG, Daejeon (KR); Seung Hyun YOON, Daejeon (KR); Byeong Sik KIM, Daejeon (KR); Tae Yeon KIM, Daejeon (KR); Byung Joon LEE, Daejeon (KR); Hong Seok JEON, Daejeon (KR); Byong Kwon MOON, Daejeon (KR); Hyung Seok CHUNG, Daejeon (KR); In Sang CHOI, Daejeon (KR)

(73) Assignee: Electronics and Telecommunications Research Institute, Daejeon (KR)

(21) Appl. No.: 14/095,721

(22) Filed: Dec. 3, 2013

(30) Foreign Application Priority Data
Dec. 11, 2012 (KR) 10-2012-0143593

(51) Int. Cl. H04L 12/26

(52) U.S. Cl. CPC H04L 43/08
USPC 709/224

(57) ABSTRACT

In order to easily prevent traffic of a content data server, which provides an arbitrary content, from being overloaded, the content transmission system according to an exemplary embodiment includes a content data server which provides an arbitrary content to a plurality of terminals when a request signal for the arbitrary content is input from the plurality of terminals, a data control server which when the arbitrary content is provided, monitors whether the traffic of the content data server is overloaded and if the traffic is overloaded as a result of monitoring, generates a traffic distribution request signal, and a node control server which when the traffic distribution request signal is input from the data control server, controls to provide the arbitrary content to an arbitrary distribution node, which satisfies a setting standard among a plurality of distribution nodes, to be provided to an arbitrary terminal among the plurality of terminals.

### CROSS-REFERENCE TO RELATED APPLICATIONS

This application claims priority to and the benefit of Korean Patent Application No. 10-2012-0143593 filed in the Korean Intellectual Property Office on Dec. 11, 2012, the entire contents of which are incorporated herein by reference.

### TECHNICAL FIELD

Embodiments relate to a content transmission system, and more specifically, to a content transmission system which is easy to prevent traffic of a content data server, which provides an arbitrary content, from being overloaded.

### BACKGROUND ART

A general content transmission system is a system which is connected to an origin server included in a content data server and a content service node which performs content routing and streaming one to one to receive a service through a terminal.

The content transmission system forms a centralized structure so that as the number of individual terminals and a request bandwidth are increased, the traffic between the origin server and the network becomes overloaded, which may cause deterioration in the quality thereof.

In order to solve such a problem, an expansion method in which a server farm which forms many content server host groups is configured or after providing many virtual machines in a strong host, the number of servers is increased in accordance with the increase in traffic is chosen. A load balancing function is provided to check availability of each host or each virtual machine so as to distribute traffic load to a portion having less load. However, traffic overload of the network is not still solved and response to excessive increase of traffic cannot be sufficiently alleviated.

Recently, a study which prevents the traffic of the content data server from being overloaded is in progress.

### SUMMARY OF THE INVENTION

The present invention has been made in an effort to provide a content transmission system which is easy to prevent traffic of a content data server, which provides an arbitrary content, from being overloaded.

An exemplary embodiment of the present invention provides a content transmission system including: a content data server which provides an arbitrary content to a plurality of terminals when a request signal for the arbitrary content is input from the plurality of terminals, a data control server which when the arbitrary content is provided, monitors whether the traffic of the content data server is overloaded and if the traffic is overloaded as a result of monitoring, generates a traffic distribution request signal, and a node control server which when the traffic distribution request signal is input from the data control server, controls to provide the arbitrary content to an arbitrary distribution node, which satisfies a setting standard among a plurality of distribution nodes, to be provided to an arbitrary terminal among the plurality of terminals.

In the content transmission system according to the exemplary embodiment, a data control server monitors whether the traffic in a content data server is overloaded. If the traffic is overloaded, when the data control server generates a traffic distribution request signal to transmit the signal to a node control server, the node control server selects an arbitrary distribution node, which satisfies a setting standard from a plurality of distribution nodes, to provide a content service image and transmits the arbitrary content to the terminal using the arbitrary distribution node so that the traffic is distributed.

The content transmission system according to an exemplary embodiment distributes the traffic to prevent deterioration in a content quality. If the traffic overload is resolved, the transmitted content service image is collected so that the utilization of the arbitrary distribution node is increased.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a system diagram schematically illustrating a content transmission system according to an exemplary embodiment.

FIG. 2 is a control block diagram illustrating a control configuration of a content transmission system according to an exemplary embodiment.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

An exemplary embodiment may have various modifications and various forms and specific exemplary embodiments will be illustrated in the drawings and described in detail in the detailed description. However, it should be understood that the exemplary embodiment is not limited to the specific examples, but includes all changes, equivalents, or alternatives which are included in the spirit and technical scope of the exemplary embodiment.

Terminologies such as first or second may be used to describe various components but the components are not limited by the above terminologies. The above terminologies are used only for distinguishing one component from the other component. For example, without departing a scope of the exemplary embodiment, the first component may be referred to as the second component and similarly, the second component is also referred to as the first component. Terminologies used in the specification are used to describe a specific exemplary embodiment but are not intended to limit the exemplary embodiment. A singular form may include a plural form if there is not a clearly described opposite meaning in the context. In this specification, it should be understood that term “include” or “have” indicates that a feature, a number, a step, an operation, a component, a part, or the combination thereof described in the specification is present, but does not exclude a possibility of presence or addition of one or more other features, numbers, steps, operations, components, parts or combinations thereof, in advance.

If it is not contrarily defined, all terms used herein including technological or scientific terms have the same meaning as those generally understood by a person with ordinary skill in the art.

Terms which are defined in a generally used dictionary should be interpreted to have the same meaning as the meaning in the context of the related art but are not interpreted as an ideally or excessively formal meaning if it is not clearly defined in this specification.

Hereinafter, exemplary embodiments will be described in detail with reference to accompanying drawings. The same reference numerals which are denoted in the drawings refer to the same components.

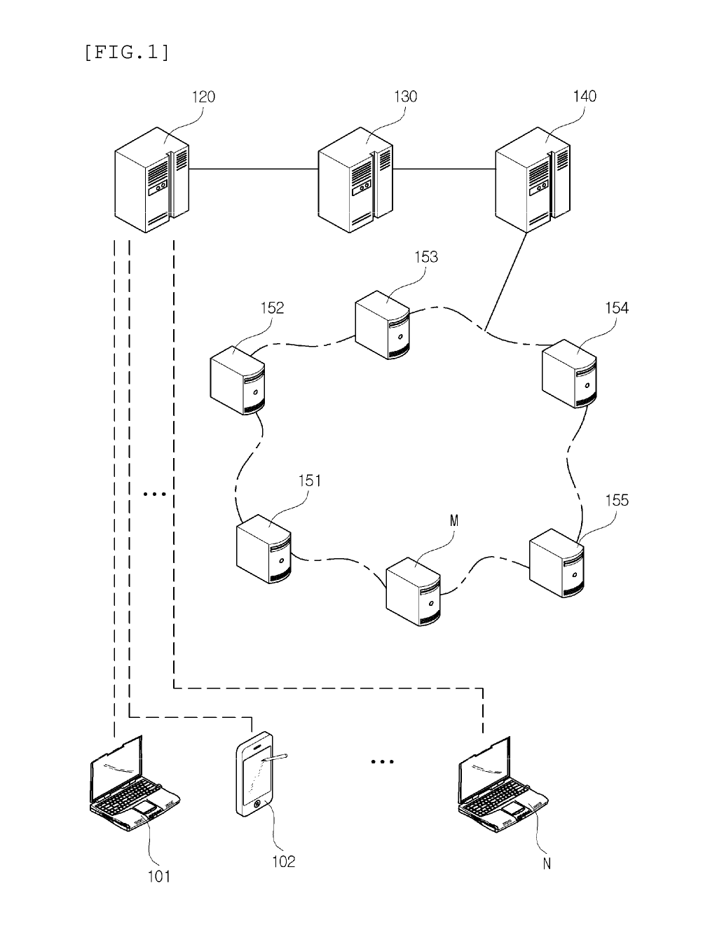

FIG. 1 is a system diagram schematically illustrating a content transmission system according to an exemplary embodiment.

Referring to FIG. 1, a content transmission system may include a plurality of terminals 101 to N, a content data server 120, a data control server 130, a node control server 140, and a plurality of distribution nodes 151 to M.

Here, the plurality of terminals 101 to N includes a smart phone and a tablet computer which are accessible to the Internet through a wireless Internet and a mobile communication network in addition to a computer terminal.

The plurality of terminals 101 to N transmits a request signal for an arbitrary content to the content data server 120 and then receives the arbitrary content to reproduce or output the arbitrary content.

If the request signal is transmitted and input from the plurality of terminals 101 to N, the content data server 120 provides the arbitrary content corresponding to the request signal to the plurality of terminals 101 to N.

The content data server 120 will be described below in detail.

In this case, the data control server 120 monitors a network traffic condition of the content data server 120.

That is, the data control server 130 monitors whether the traffic of the network is overloaded by the transmission of the arbitrary content by the request signal transmitted and input from the plurality of terminals 101 to N.

In the exemplary embodiment, the data control server 130 may be a content provider who uploads or provides a copyright or an original of the arbitrary content to the content data server 120, but is not limited thereto.

Thereafter, if it is determined that the traffic is overloaded, the data control server 130 generates a traffic distribution request signal to transmit the signal to the node control server 140. If the traffic overload is removed, the data control server 130 generates the traffic distribution removal signal to transmit the removal signal to the node control server 140.

When the traffic distribution request signal is transmitted and input from the data control server 130, the node control server 140 may select an arbitrary distribution node which satisfies the setting standard from the plurality of distribution nodes 151 to M to provide the arbitrary content thereto so that the content is provided to an arbitrary terminal among the plurality of terminals 101 to N.

That is, when the traffic distribution request signal is transmitted and input, the node control server 140 collects node information for each of the plurality of distribution nodes 151 to M and selects the arbitrary distribution node having node information which satisfies the setting standard among the node information.

In the exemplary embodiment, at least one of the plurality of distribution nodes 151 to M may be the same as the content data server 120 and the plurality of distribution nodes 151 to M and the content data server 120 may be servers which are distributed locally or in accordance with a specific standard, but is not limited thereto.

After transmitting and inputting the traffic distribution request signal, if the traffic distribution removal signal is transmitted and input from the data control server 130, the node control server 140 controls to collect the arbitrary content, which is provided to the arbitrary distribution node, to increase utilization of a node with respect to the arbitrary distribution node.

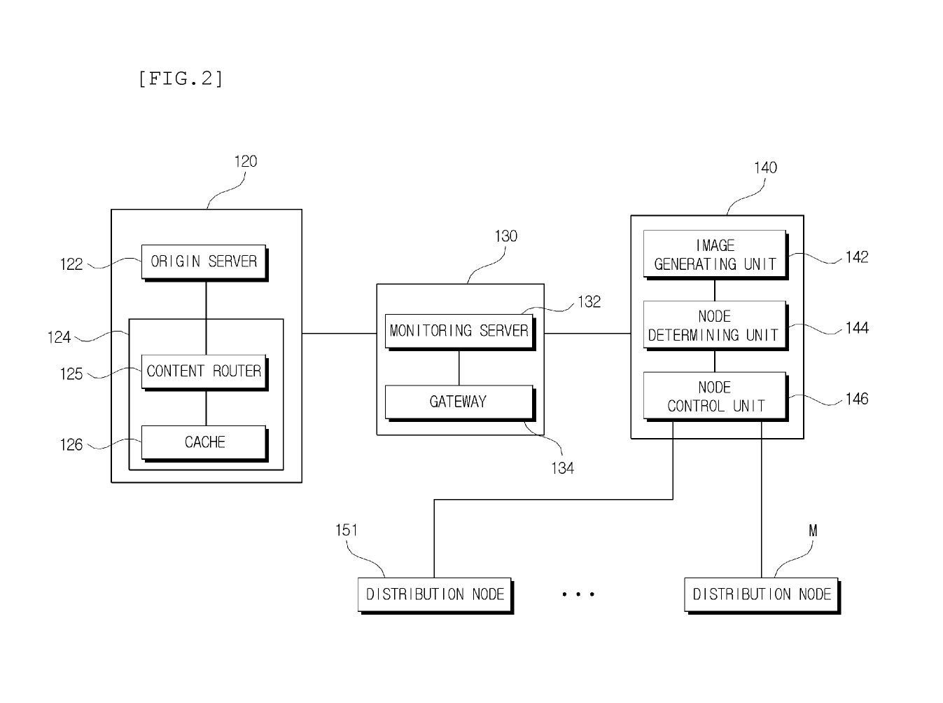

FIG. 2 is a control block diagram illustrating a control configuration of a content transmission system according to an exemplary embodiment.

Referring to FIG. 2, a content transmission system includes a plurality of terminals 101 to N, a content data server 120, a data control server 130, a node control server 140, and a plurality of distribution nodes 151 to M.

In the exemplary embodiment, even though it is described that the content data server 120 is a separate component from the plurality of distribution nodes 151 to M, the content data server 120 may be any one of the plurality of distribution nodes 151 to M, which will be described as an independent component for a detailed description, but is not limited thereto.

The content data server 120 includes an origin server 122 in which an original arbitrary content provided from the data control server 13 is stored and a content service node 124 which, when a request signal for the arbitrary content is transmitted and input from the plurality of terminals 101 to N, transmits the request signal to the origin server 122 and receives the arbitrary content from the origin server 122 to provide the content to the plurality of terminals 101 to N.

The origin server 122 may be provided with the original of the arbitrary content including a video such as music video and an album image or a game content from the data control server 130 to store the original of the arbitrary content.

Here, the content service node 124 includes a content router 125 which receives the request signal and transmits the arbitrary content to the plurality of terminals 101 to N which transmits the request signal and a cache 126 which stores the arbitrary content provided from the origin server 22.

The content service node 124 may manage streaming for the arbitrary content, but the exemplary embodiment is not limited thereto.

The content router 125 is a network device which refers to an address of the request signal transmitted from the plurality of terminals 101 to N to connect the address with a destination. For example, the content router 125 may be an L4/L7 router, but is not limited thereto.

The data control server 130 includes a monitoring server 132 which monitors whether the traffic of the content data server 120 is overloaded and a gateway 134 which generates the traffic distribution request signal to transmit the signal to the node control server 140 if the traffic is overloaded as a result of monitoring by the monitoring server 132.

Here, if the traffic of the content data server 120 is equal to or higher than a reference threshold value, the monitoring server 132 determines that the traffic is overloaded. In contrast, if the traffic is lower than the reference threshold value, the monitoring server 132 determines that the traffic is not overloaded.

That is, if it is determined that the traffic is overloaded, the monitoring server 132 generates the traffic distribution request signal to transmit the signal to the gateway 134.

If the traffic distribution request signal is input, the gateway 134 transmits the traffic distribution request signal to the node control server 140.

After the monitoring server 132 determines that the traffic is overloaded to generate and transmit the traffic distribution request signal, if the traffic of the content data server 120 is lowered to be lower than the reference threshold value, the monitoring server 132 generates the traffic distribution removal signal to transmit the signal to the node control server 140 through the gateway 134.

In this case, when the traffic distribution request signal is transmitted, the gateway 134 transmits the arbitrary content, but the exemplary embodiment is not limited thereto.

The node control server 140 may include an image generating unit 142 which, when the traffic distribution request signal is transmitted and input from the data control server 130, generates a content service image corresponding to the arbitrary content, a node determining unit 144 which determines whether the node information transmitted from each of the plurality of distribution nodes 151 to M satisfies a setting standard and selects an arbitrary distribution node which satisfies the setting standard, and a node control unit 146 which controls to transmit and install the content service image generated by the image generating unit 142 to the arbitrary distribution node selected by the node determining unit 144 and to provide the arbitrary content to an arbitrary terminal among the plurality of terminals 101 to N.

The node determining unit 144 receives node information of each of the plurality of distribution nodes 151 to M from the plurality of distribution nodes 151 to M in accordance with the control of the node control unit 146 to select the arbitrary distribution node which satisfies the setting standard.

Here, the node information may include at least one of repeated information for the arbitrary content, access status information with another terminal, node available capacity information, and network situation information, but is not limited thereto.

That is, the node determining unit 144 selects the arbitrary distribution node which is maintained at an optimal status in at least one distribution node which satisfies the setting standard among the plurality of distribution nodes 151 to M.

In this case, the node control unit 146 may control the content service image to be transmitted to and installed in the arbitrary distribution node selected by the node determining unit 144 and the arbitrary content by the content service image to be transmitted to the arbitrary terminal among the plurality of terminals 101 to N.

In the exemplary embodiment, the plurality of distribution nodes 151 to M may have the same configuration as the content data server 110 and may be configured by the content router and the server, but is not limited thereto.

If the traffic distribution removal signal is transmitted and input from the data control server 130, the node control unit 146 may control the content service image, which is previously provided from the arbitrary distribution node, to be collected to increase availability of the arbitrary distribution node.

In the exemplary embodiment, the node control server 140 transmits the arbitrary content to the arbitrary distribution nodes whose availability is optimal through the node information of the plurality of distribution nodes 151 to M. However, the node control server 140 may collect and store traffic measurement of the plurality of distribution nodes 151 to M, the number of users, and monitoring information regarding whether the network is trouble, but is not limited thereto.

The exemplary embodiment may be implemented in a computer readable recording medium as a computer readable code. The computer readable recording medium includes all types of recording device in which data readable by a computer system is stored. Examples of the computer readable recording medium are ROM, RAM, CD-ROM, a magnetic tape, a floppy disk, an optical data storing device and also implemented as a carrier wave (for example, transmission through the Internet). The computer readable recording medium is distributed in computer systems connected through a network and a computer readable code is stored therein and executed in a distributed manner.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A content transmission system, comprising:
a content data server which provides an arbitrary content to a plurality of terminals when a request signal for the arbitrary content is input from the plurality of terminals;
a data control server which when the arbitrary content is provided, monitors whether the traffic of the content data server is overloaded and if the traffic is overloaded as a result of monitoring, generates a traffic distribution request signal, and
a node control server which when the traffic distribution request signal is input from the data control server, controls to provide the arbitrary content to an arbitrary distribution node, which satisfies a setting standard among a plurality of distribution nodes, to be provided to an arbitrary terminal among the plurality of terminals.

2. The system of claim 1, wherein the content data server includes:
a content service node to which the request signal is input and which transmits the arbitrary content; and
an origin server which if the request signal is input from the content service node, provides the arbitrary content to the content service node.

3. The system of claim 2, wherein the content service node receives the request signal, transmits the arbitrary content provided from the origin server to the plurality of terminals, and manages the streaming of the content.

4. The system of claim 2, wherein the content service node includes a cache which stores the arbitrary content provided from the origin server.

5. The system of claim 1, wherein the data control server includes:
a monitoring server which monitors whether the traffic of the content data server is overloaded; and
a gateway which, if the traffic is overloaded as a result of the monitoring of the monitoring server, generates the traffic distribution request signal to transmit the signal to the node control server.

6. The system of claim 5, wherein if the traffic of the content data server is equal to or larger than a reference threshold value, the monitoring server determines that the traffic is overloaded.

7. The system of claim 5, wherein if the traffic is overloaded, the gateway transmits the traffic distribution request signal and the arbitrary content to the node control server.

8. The system of claim 1, wherein the node control server includes:
an image generating unit which, when the traffic distribution request signal is input, generates a content service image corresponding to the arbitrary content transmitted from the monitoring server;
a node determining unit which determines whether the node information transmitted from each of the plurality of distribution nodes satisfies the setting standard; and
a node control unit which transmits and installs the content service image to the arbitrary distribution node which satisfies the setting standard among the plurality of distribution nodes from the node determining unit and provides the arbitrary content to the arbitrary terminal.

9. The system of claim 8, wherein the node information includes at least one of repeated information for the arbitrary content, access status information with another terminal, node available capacity information, and network situation information.

10. The system of claim 1, wherein at least one of the plurality of distribution nodes is the same as the content data server.

11. The system of claim 1, wherein after transmitting the traffic distribution request signal, if the traffic overload is removed, the data control server generates a traffic distribution removal signal.

12. The system of claim 11, wherein if the traffic distribution removal signal is input from the data control server, the node control server collects the arbitrary content provided from the arbitrary distribution node.
